(19) United States
(12) Patent Application Publication
(10) Pub. No.: US 2007/0281730 A1
(43) Pub. Date: Dec. 6, 2007

(54) Mobile Terminal And Mobile Terminal Control Method

(75) Inventor: Masao Ichi, Osaka (JP)

Correspondence Address: KRATZ, QUINTOS & HANSON, LLP, 1420 K Street, N.W., Suite 400, WASHINGTON, DC, 20005, US

(73) Assignee: SANYO ELECTRIC CO.,LTD., MORIGUCHI-SHI (JP)

(21) Appl. No.: 10/585,300

(22) PCT Filed: Dec. 15, 2004
(86) PCT No.: PCT/JP04/18758

§ 371 Date: May 25, 2007

(30) Foreign Application Priority Data
Jan. 8, 2004 (JP) 2004-002676

(51) Int. Cl. H04M 1/00

(52) U.S. Cl. 455/550.1

(57) ABSTRACT

The present invention aims at offering a mobile terminal capable of obtaining information related to the purpose of the caller who made a communication request in an emergency or business situation while the connection to the communication request destination is not established. If determining that establishment of a communication connection requires time after a communication request to a telephone number registered to the channel select information table 901 stored in the information storage unit 130 was made, the control unit 200 instructs the broadcast receiving unit 170 to receive broadcast according to a registered channel information piece in association with the telephone number in the channel information table. In addition, when a reply signal indicating that the establishment of the communication connection is currently not possible, the control unit retransmits the request until predetermined number of retransmission is reached.

### TECHNICAL FIELD

The present invention relates to a mobile terminal, especially to a mobile terminal having a telephone function and a broadcast receiving function.

### BACKGROUND ART

Improvements of systems for warning accidents and fires have been driven by the need in the national, autonomous and local communities. As part of the measures, a Japanese patent document discloses a technology related to a warning system for people in housing complexes (Patent Reference 1). Public and commercial broadcasting also plays an important roll as an emergency warning system.

Recent mobile terminals are being developed into communication devices having integrated functions that include a telephone function, a function of receiving broadcast services, such as digital and analog TV broadcast, and a function of receiving AM and FM radio broadcasts in addition to a function of communicating data via the Internet. Accordingly, the users are able to report and provide information and also collect reported information through broadcasting services.

<Patent Reference 1>Japanese Laid-Open Patent Application Publication No. H09-172500.

### DISCLOSURE OF THE INVENTION

[Problem that the Invention is to Solve]

However, when major accidents occur, it is often the case that making an emergency call “110” to the police (“911” in the United States) and a telephone call “119” for the fire department becomes difficult. Besides such emergency calls, communication lines to public or commercial information services or booking services often get overloaded, and the communication base stations send back signals informing that the connection is not able to be established. In such a case, the caller has to make a call again. In a similar case where a connection is hard to establish and a signal of a voice message saying “Please hold the line” is sent back, the caller has to wait until the telephone call gets through.

In view of the above issues, the present invention aims at offering a mobile terminal capable of obtaining information related to the purpose of the caller who made a communication request in an emergency or business situation, so as not to waste the caller's waiting time when the establishment of the connection to the requested communication destination seemingly takes time.

[Means to Solve the Problem]

In order to solve the above problems, the present invention is a mobile terminal having a telephone function and a broadcast receiving function. The mobile terminal comprises: a storage unit storing one or more telephone numbers, each of which is associated with one or more channel information pieces; a judging unit operable to judge, in a case where a caller makes a request for establishing a communication connection to one of the telephone numbers, whether the establishment requires time based on a reply signal from a communication base station that has received the request; an extraction unit operable to perform a search in the storage unit when the judging unit determines that the establishment requires time, and extract the one or more channel information pieces associated with the one of the telephone numbers; and a broadcast reception unit operable to receive a broadcast service using by one of the extracted channel information pieces.

[Advantageous Effects of the Invention]

According to the above structure, in the case where the user calls a telephone number stored in the storage unit and the judging unit determines that the establishment requires time according to the reply signal from the communication base station in response to the request, the broadcast reception unit receives broadcast service indicated by a channel information piece associated with the telephone number. As a result, the user is able to obtain necessary information through the broadcast service, wasting no time.

The judging unit determines that the establishment requires time when the reply signal is one of a 1st reply signal indicating that the establishment is not possible and a 2nd reply signal instructing the caller to hold.

Accordingly, in the case where the reply signal from the communication base station is a signal indicating that the establishment is currently not possible or a voice message instructing the caller to hold the line, the broadcast reception unit receives broadcast service indicated by a channel information piece associated with the telephone number. As a result, the user is able to obtain necessary information through the broadcast service.

The mobile terminal further comprises: a retransmission unit operable to repeatedly retransmit, while the broadcast reception unit is receiving the broadcast service as a result of the reply signal being the 1st reply signal, the request at specified time intervals after reception of the 1st reply signal, until the judging unit determines that the establishment requires no time or until predefined number of retransmissions is reached.

Accordingly, when the reply signal indicates that the establishment is currently not possible, the retransmission unit repeatedly retransmits the request at specified time intervals, which saves the user's trouble.

The mobile terminal further comprises: a broadcast reception terminating unit operable to terminate the reception of the broadcast service when the judging unit determines that the establishment requires no time.

Accordingly, when the judging unit determines, in response to the retransmission, that the establishment requires no time, the reception of the broadcast service is terminated. As a result, the user is able to concentrate on talking to the communication request destination without being disturbed by the broadcast service.

The mobile terminal further comprises: a broadcast reception terminating unit operable to terminate the reception of the broadcast service when the judging unit determines that the establishment requires no time in a case where the broadcast reception unit is receiving the broadcast service as a result of the reply signal being the 2nd reply signal.

Accordingly, when the judging unit determines that the establishment requires no time in the case where the broadcast reception unit is receiving the broadcast service as a result of the reply signal instructing the user to hold the line, the reception of the broadcast service is terminated. As a result, the user is able to concentrate on talking to the communication request destination without being disturbed by the broadcast service.

The mobile terminal further comprises: a detecting unit operable to detect airwave intensity. Here, in a case where airwave intensity of the received broadcast service is less than a predefined value and there are a plurality of the extracted channel information pieces, the broadcast reception unit receives, singly and sequentially in order of extraction, broadcast services indicated by the plurality of the extracted channel information pieces until obtaining airwave intensity of a received broadcast service having the predefined value or more.

Assume the case where there are a plurality of channel information pieces associated with the telephone number prestored in the storage unit, and the airwave of the broadcast service specified by the first channel information piece is weak and it is therefore difficult to listen to the broadcast service. According to the above structure, the user is able to obtain necessary information from an available broadcasting channel selected from the rest of the channel information pieces.

The request is to establish an emergency communication connection to police or fire department.

Accordingly, even if incidences, accidents, earthquakes or the like occur, the user is able to obtain the latest information through a broadcast service associated with the telephone number until the condition where the user can make reports or inquiries is restored.

In order to solve the above problems, the present invention is a control method of a mobile terminal including a storage unit storing one or more telephone numbers, each of which is associated with one or more channel information pieces, and having a telephone function and a broadcast receiving function, the control method comprising the steps of: judging, in a case where a caller makes a request for establishing a communication connection to one of the telephone numbers, whether the establishment requires time based on a reply signal from a communication base station that has received the request; performing a search in the storage unit when the judging unit determines that the establishment requires time, and extracting the one or more channel information pieces associated with the one of the telephone numbers; and receiving a broadcast service indicated by one of the extracted channel information pieces.

According to the method, when the user calls a telephone number prestored in the storage unit and it seems that the establishment of the communication connection takes time, a broadcast service specified by a channel information piece associated with the telephone number is received. As a result, the user is able to obtain necessary information through the broadcast service, wasting no time.

### BRIEF DESCRIPTION OF THE DRAWINGS

FIG. 1 is a block diagram of a preferred embodiment of a mobile terminal—a cell phone—according to the present invention;

FIG. 2 shows an appearance example of the front side of the above embodiment;

FIG. 3 shows examples of voice waveforms of WAIT fixed phrase of the above embodiment;

FIG. 4 shows an example of a channel information table of the above embodiment;

FIG. 5 shows a menu of the above embodiment;

FIG. 6 shows an example of a channel information summary of the above embodiment;

FIG. 7 shows an example of a registration reference screen for a channel information piece of the above embodiment;

FIG. 8 shows an example of a channel information list of a specified telephone number of the above embodiment;

FIG. 9 shows an example of a channel information table to which another channel information piece has been added to the channel information table of FIG. 4;

FIG. 10 shows a channel information summary of the channel information table of FIG. 9;

FIG. 11 shows an example of an environment in which a cell phone performs communication request transmission and broadcast reception;

FIG. 12 shows an example in which a cell phone is receiving broadcast according to a channel information piece of the above embodiment;

FIG. 13 is a first half of a flowchart showing operations of the above embodiment; and

FIG. 14 is a second half of the flowchart showing operations of the above embodiment.

### EXPLANATION OF REFERENCES

101 radio unit
110 communication unit
120 voice processing unit
121 microphone (telephone transmitter)
122 speaker (telephone receiver)
125 voice judging unit
130 information storage unit
150 operation unit
151 menu button
153 on-hook button
154 off-hook button
155 OK button
156 UP button
157 DOWN button
158 LEFT button
159 RIGHT button
160 display unit
170 broadcast receiving unit
180 channel information registration unit
200 control unit
301 fixed phrase waveform (1)
302 fixed phrase waveform (2)
401 channel information table
501 broadcast menu
601 channel information summary
701 channel information registration reference screen
801 channel information list
901 channel information table (after addition of a channel information piece)
1001 channel information summary (after addition of a channel information piece)
1101 communication request
1102 communication network
1103 traffic information center
1104 broadcast station
1105 airwave
   [Best Mode for Carrying Out the Invention]

Next is described a preferred embodiment of a mobile terminal—a cell phone—according to the present invention with the aid of drawings.

### EMBODIMENT

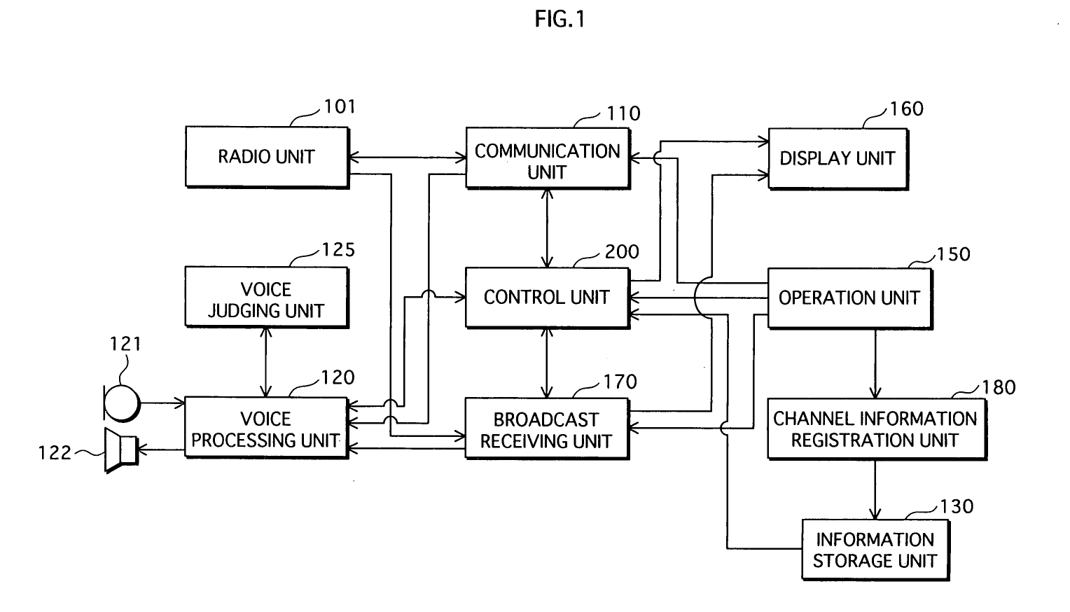

FIG. 1 is a block diagram of the present embodiment. The cell phone comprises: a radio unit 101; a communication unit 110; a voice processing unit 120; a microphone 121; a speaker 122; a voice judging unit 125; an information storage unit 130; an operation unit 150; a display unit 160; a broadcast receiving unit 170; a channel information registration unit 180; and a control unit 200.

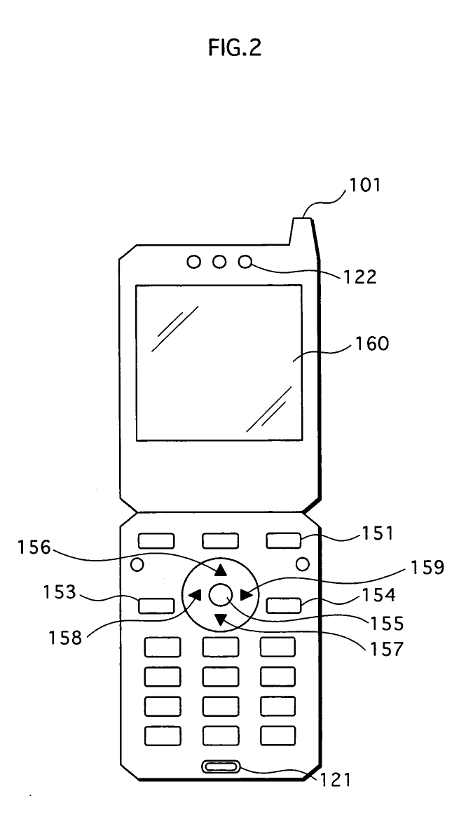

FIG. 2 shows an appearance example of the front side of the folding cell phone of the present embodiment in an open state. Some of the components with reference numerals in FIG. 2 correspond to components having the same reference numerals in FIG. 1.

The radio unit 101 receives from a communication base station (not shown) a reply signal in response to a communication request, an incoming signal, audio, and airwaves of television or radio broadcast. Then, the radio unit 101 transmits the audio to the communication unit 110, and transmits the broadcast to the broadcast receiving unit 170. In addition, the radio unit 101 also conducts operations in the reverse direction, transmitting to the communication base station a communication request received from the communication unit 110 and modulated signals, such as voice of the speaker of the cell phone.

The communication unit 110 demodulates the modulated signals of radio waves received from the radio unit 101 to signals of the voice of the person on the other end, and outputs the voice to the voice processing unit 120. Also the communication unit 110, reversely, transmits to the radio unit 101 modulated signals of the voice of the speaker of the cell phone.

When the user pushes an off-hook button 154 after conducting an operation for a communication request—for example, entering a phone number by pushing on the number buttons, the communication unit 110 carries out a process of transmitting the communication request. To be more specific, the communication unit 110 generates a signal for the communication request, and transmits the signal to the radio unit 101 while notifying the control unit 200 that the signal of the communication request to the telephone number is transmitted to the communication base station in response to the user operation. In addition, the communication unit 110 receives via the radio unit 101 a reply signal transmitted from the communication base station as a signal in response to the communication request, and transmits the signal to the control unit 200. Here, the reply signal is a tone or a signal of a voice message that the communication base station itself transmits to the communication requestor. The reply signal is hereinafter simply referred to as a “reply”. The communication request is a signal requesting to establish a communication connection for a call.

If instructed by the control unit 200 to perform retransmission (to be hereinafter described), the communication unit 110 places a communication request to the telephone number, and informs the control unit 200 to that effect.

The voice processing unit 120 transmits to the communication unit 110 the voice of the speaker of the cell phone received from the microphone 121. In addition, the voice processing unit 120 outputs a signal received from the communication unit 110 to the speaker 122. Here, if the received signal is a voice signal and the voice processing unit 120 has been instructed by the control unit 200 to perform voice judgment, the voice processing unit 120 transmits the voice to the voice judging unit 125. The voice processing unit 120 then receives a judgment result from the voice judging unit 125 and informs the control unit 200 of the judgment result.

The voice judging unit 125 performs judgment regarding whether the voice message transmitted from the voice processing unit 120 is a message indicating WAIT (hereinafter “WAIT message”), based on fixed phrases, and informs the voice processing unit 120 about the judgment result.

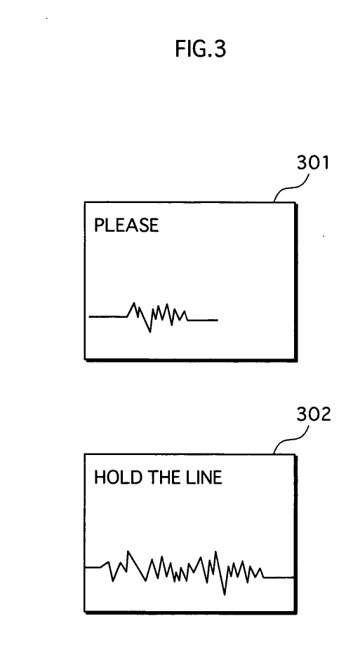

FIG. 3 shows two fixed phrases used by the voice judging unit 125 for judging whether a voice message is WAIT message, and examples of voice waveforms of the fixed phrases. Information related to the waveforms of these fixed phrases is stored inside the voice judging unit 125. A fixed phrase waveform 301 is a voice waveform of “please” while a fixed phrase waveform 302 is a voice waveform of “hold the line”. Furthermore, “Just a moment, please”, “Please wait for a while” and the like may be added.

The voice judging unit 125 does not store the waveforms of these fixed phrases themselves, but calculates characteristics of each fixed phrase by voice analysis, and stores therein the calculated amount of the standard characteristic. The voice judging unit 125 judges whether the amount of characteristic of the waveform of part of the voice message transmitted from the voice processing unit 120 matches the amount of standard characteristic of the waveforms of these fixed phrases. When they show a certain degree of agreement, the voice judging unit 125 determines that the voice message is WAIT message.

The information storage unit 130 is realized by a RAM (Random Access Memory) and a ROM (Read Only Memory), and stores therein channel information pieces for receiving broadcast when establishment of a communication connection in response to a transmission is determined to require time.

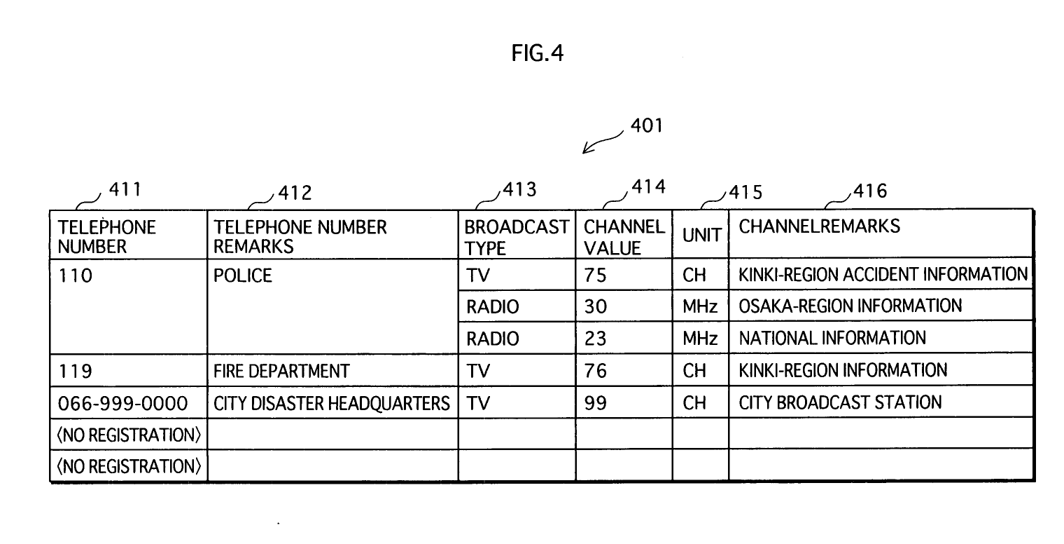

FIG. 4 shows an example of a channel information table including channel information pieces. A channel information table 401 has registration items of telephone number 411, telephone number remarks 412, broadcast type 413, channel value 414, unit 415 and channel remarks 416. Each of the channel select information pieces in the channel information table 401 is registered and referred to by the channel information registration unit 180.

The telephone number 411 includes telephone numbers of transmission destinations. The telephone number remarks 412 describe names of the communication destinations of the telephone number 411 and the like. The broadcast type 413 indicates types of broadcast to be received, and there are, for example, TV broadcast (including terrestrial broadcast and satellite broadcast) and radio broadcast (including medium frequency wave, high frequency wave, FM and FM teletext broadcast).

The channel value 414 specifies a channel number or a frequency. For a channel number, one set in the broadcast receiving unit 170 is specified. The unit 415 specifies a channel (CH) when the channel value 414 is a channel number, and specifies MHz or KHz when the channel value 414 is a frequency. The channel remarks 416 describe names of the channels and the like.

The user can specify one or more channel information pieces for one telephone number. In the channel information table 401, three channel information pieces are described for a telephone number 110 in the order of registration. Note that there is no limit on the number of telephone numbers and the number of channel information pieces to be registered.

The operation unit 150 is made up of various buttons for receiving user operations. The operations by the user include transmission and reception of telephone calls, registration and reference to the channel information table 401 and the like. The lower part of FIG. 2 shows arrangement of various buttons of the operation unit 150. The buttons of the operation unit 150 include a menu button 151, an on-hook button 153, an off-hook button 154, an OK button 155, an UP button 156, a DOWN button 157, a LEFT button 158, a RIGHT button 159, and various buttons for numbers and letters.

When the on-hook button 153 or the off-hook button 154 for a telephone call is pushed, the operation unit 150 informs the communication unit 110 accordingly. When the menu button 151 is pushed, the operation unit 150 informs the control unit 200 about the effect. If a button operation for registration is performed to register or refer to a channel information piece, the operation unit 150 informs the channel information registration unit 180 accordingly.

The display unit 160 is realized by a liquid crystal panel, for example. Based on control of the control unit 200, broadcast receiving unit 170 and channel information registration unit 180, the display unit 160 displays information for registration and reference to the channel information table 401, menus, texts for FM teletext broadcast and the like, and a screen in the TV mode.

The broadcast receiving unit 170 starts or ends radio or TV broadcast reception according to a user operation on the operation unit 150 or an instruction from the control unit 200. The broadcast receiving unit 170 receives, together with an instruction of the control unit 200 for starting broadcast reception, a channel information piece including a broadcast type (either radio or TV) and a frequency or a channel number (for example, an allocated channel number of VHF, UHF or SHF in the case of analog broadcasting), and selects a channel.

In addition, the broadcast receiving unit 170 detects an electric field intensity which indicates an intensity of the airwave of the selected channel, and informs the control unit 200 about the detected electric field intensity.

Based on the user operation, the channel information registration unit 180 registers, to the channel information table 401 of the information storage unit 130, channel information in which telephone numbers of communication destinations including police, fire department and the like are associated with channel information pieces related to the broadcast service of the communication destinations. The channel information registration unit 180 refers to the channel information table 401.

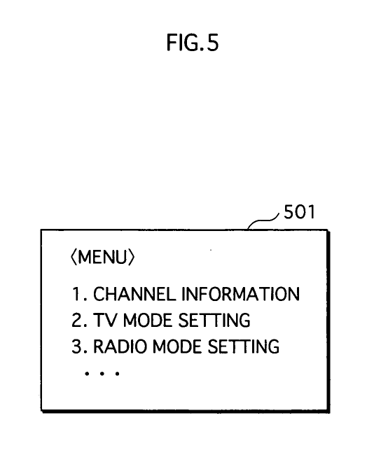

FIG. 5 shows a broadcast menu used in various operations including operations on the channel information pieces. The broadcast menu 501 is displayed on the display unit 160 by the control unit 200. When the user pushes the number button “1” and OK button 155 of the operation unit 150 for registration of a channel information piece, the push-down operations are informed by the operation unit 150 to the control unit 200, and the channel information registration unit 180 is started by the control unit 200.

The started channel information registration unit 180 reads the channel information table 401, and displays, on the display unit 160, a summary of the channel information pieces in which each set of the telephone number 411 and telephone number remarks 412 is shown in one line.

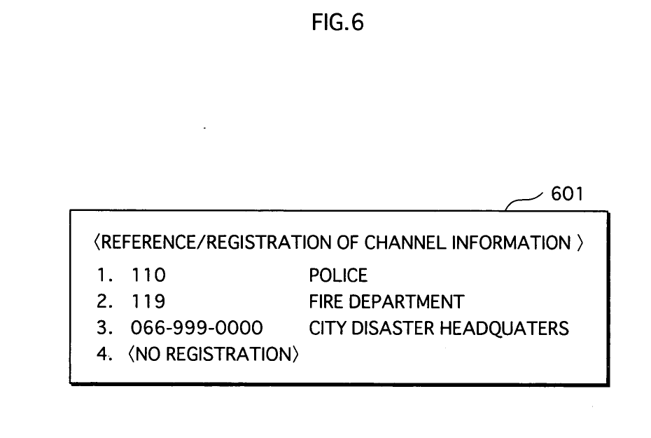

FIG. 6 shows a display example of the channel information summary A channel information summary 601 shows that three telephone numbers have already been registered to the channel information table 401.

If “no registration” of the fourth item is selected by the user by pushing the number button “4” and OK button 155 when the channel information summary 601 is displayed, the channel information registration unit 180 is informed of the push-down operations by the operation unit 150, and adds a new channel information piece to the channel information table 401 of the information storage unit 130.

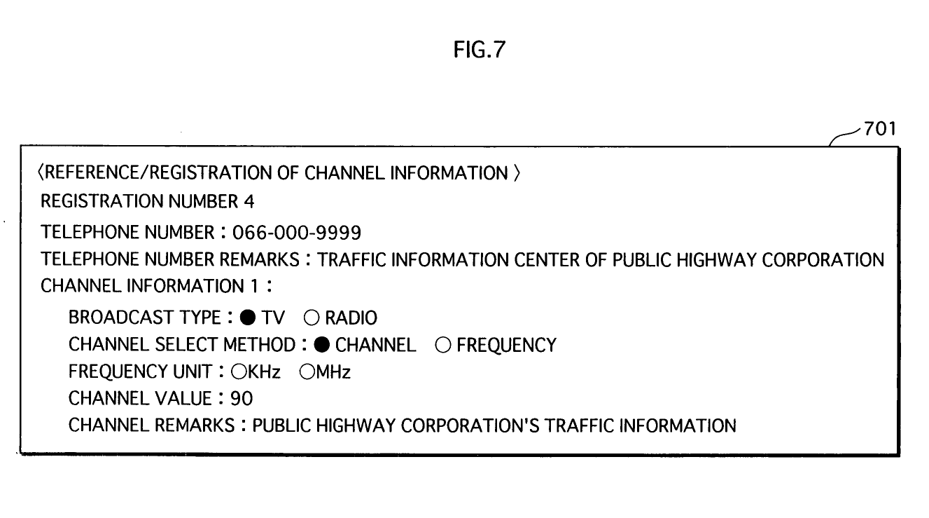

FIG. 7 shows an example of a screen for additional registration of a channel information piece displayed by the channel information registration unit 180. In a channel information registration reference screen 701, a telephone number, telephone number remarks and a first channel information piece corresponding to the telephone number are entered by the user. For selecting an entry item, the UP button 156 and DOWN button 157 are used. Items for letter and number entry are filled by using the letter and number buttons. In order to specify the broadcast type, channel select method and frequency unit, the LEFT button 158 and RIGHT button 159, and subsequently the OK button 155 are used. When the entry is completed, the user pushes the OK button 155 once again. These push-down operations are informed by the operation unit 150 to the channel information registration unit 180. The channel information registration unit 180 adds information regarding the new telephone number to the channel information table 401 while displaying a channel information list of the telephone number.

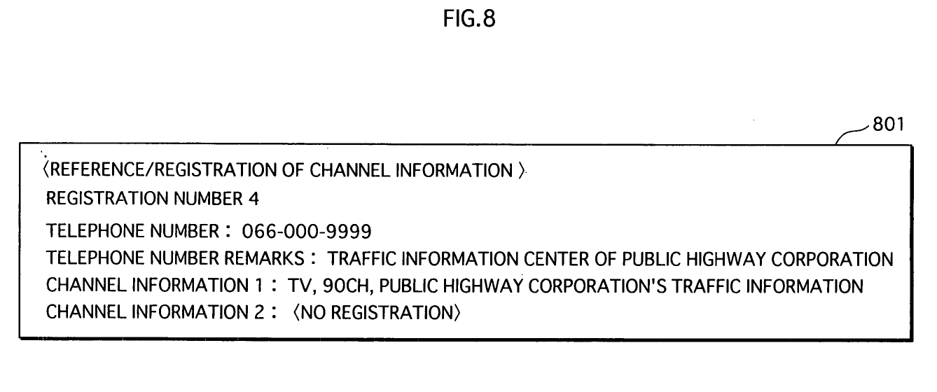

FIG. 8 shows a display example of a channel information list 801 relating to the specific telephone number. Here, the “registration number” indicates the registration order of the telephone number. In relation to the telephone number, the user can add a second channel information piece as “channel information 2”. In order to make this addition, the channel information 2 is selected using the UP button 156 and DOWN button 157, and then the OK button 155 is pushed. After informed by the operation unit 150 about these push-down operations, the channel information registration unit 180 displays entry items of the channel information 2 (not shown) on the channel information registration reference screen 701, in place of the channel information 1. Accordingly, the user may perform information entry or adding operations in the same manner as for the channel information 1.

When the addition of a channel information piece is not made on the channel information registration reference screen 701, the channel information registration unit 180 displays the latest channel information list in response to the OK button 155 being pushed.

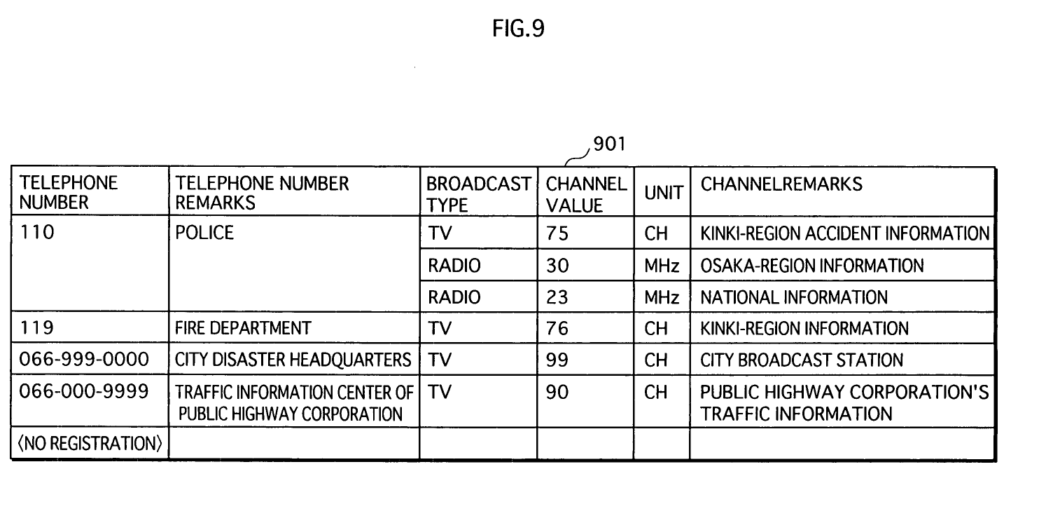

FIG. 9 shows a channel information table 901 to which a fourth telephone number has been added to the channel information table 401.

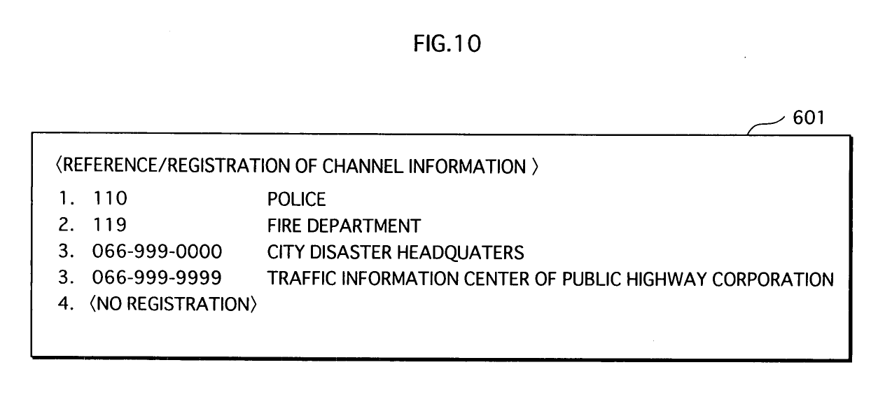

FIG. 10 shows a channel information summary 1001 of the channel information table 901.

If the user wants to refer to a specific telephone number in the channel information summary 1001, the user selects a line of the telephone number and pushes the OK button 155. Informed by the operation unit 150 about the push-down operation, the channel information registration unit 180 displays the channel information list 801 of the telephone number.

If the user wants to make corrections on a channel information piece when the channel information list 801 is being displayed, the user selects a channel information desired to be corrected and then pushes the OK button 155. When informed by the operation unit 150 about the push-down operation, the channel information registration unit 180 displays a screen with already registered information, similar to the channel information registration reference screen 701. The user can make corrections on registration items of a desired channel information piece by performing similar operations as those performed for new registration. In addition, when desiring to add a channel information piece during the display of the channel information list 801, the user selects an item of “no registration” for the channel information piece and adds information.

When wanting to delete a channel information piece during the display of the channel information list 801, the user selects the item of the channel information piece and pushes the letter button “#” and subsequently pushes the “D” button. Receiving the push-down operations from the operation unit 150, the channel information registration unit 180 deletes the specified channel information piece from the channel information table 901. If no channel information piece is left for the telephone number as a result of the deletion, the channel information registration unit 180 also deletes information of the telephone number.

The control unit 200 performs control of broadcast reception and processing of the broadcast menu.

First, the control of broadcast reception is described. When an operation for a communication request to a telephone number is performed by the user, the communication unit 110 notifies the control unit 200 that the communication request to the telephone number has been made by the user.

The control unit 200 receives the notification and checks whether the telephone of the communication request destination has been registered to the channel information table 901. If the telephone number has not been registered, the control unit 200 withholds exercising the control of broadcast reception to be described below.

The control unit 200 receives a first reply from the communication base station in response to the communication request. When the reply is a voice message, the control unit 200 instructs the voice processing unit 120 to judge whether the reply is WAIT message.

The control unit 200 checks whether the reply is BUSY. BUSY reply is obtained when a signal indicating that a communication connection in response to the communication request cannot be established (e.g. a busy tone) is returned from the communication base station due to the communication line getting overloaded and being in a congestion state, or due to the communication request destination being already engaged. Here, the communication connection means an establishment of a communication path implemented by the communication base station or the like for allowing the communication requestor to communicate with the communication request destination, and a communication connection being unable to be established means that the communication path cannot be established.

When the reply is a voice message, the control unit 200 is informed by the voice processing unit 120 about a judgment regarding whether the voice message is WAIT message. When the judgment of the voice processing unit 120 is affirmative, the reply is WAIT. Here, WAIT message is a voice message indicating, for example, that the communication base station or the like is trying to establish a communication connection with the communication request destination although the communication line in the communication network is congested. WAIT message is sent from the communication base station or the like to the communication requestor in the case where there is a chance that the communication connection may be established in due course if the communication request is not cancelled.

For the communication request to a telephone number registered to the channel information table 901, if the replay is BUSY or WAIT, the control unit 200 determines that the communication connection requires time, and controls the broadcast receiving unit 170 to receive broadcast according to a channel information piece registered in association with the telephone number.

When the reply is neither BUSY nor WAIT, the control unit 200 determines that the communication connection does not require time and withholds exercising the control of broadcast reception. This process is taken, for example, when the communication base station calls the communication request destination according to a signal of the communication request, using a calling signal for notifying the communication request destination about the incoming call, and the communication base station sends a ringback tone back as the reply if the telephone of the communication request destination is not engaged. Here, if the communication request destination answers the call (off-hook operation) while being called, the communication connection is established and the users are able to talk to each other.

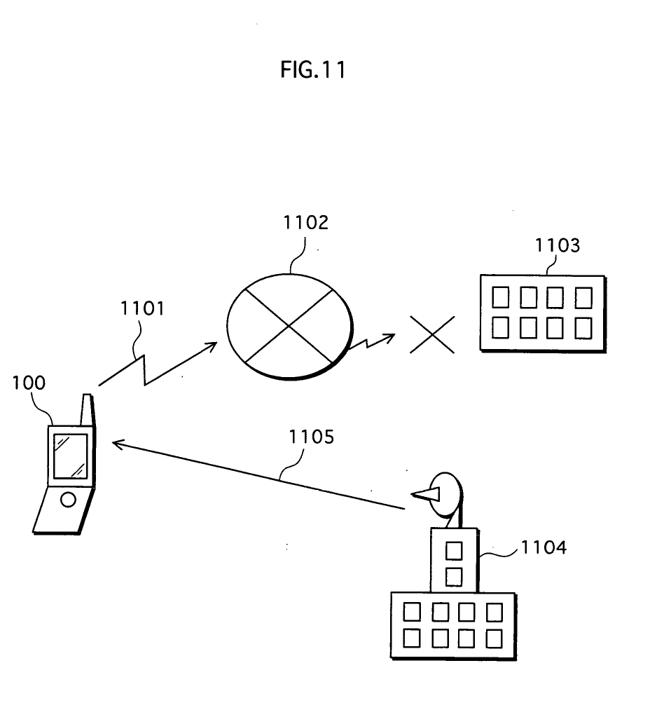

FIG. 11 shows an example of an environment in which a cell phone performs communication request transmission and broadcast reception.

In FIG. 11, the cell phone 100 makes a communication request 1101 to a traffic information center 1103 via a communication network 1102. When determining that the communication connection has not been established, the control unit 200 :extracts all channel information pieces for the telephone number of the communication request destination if the telephone number has been registered to the channel information table 901. Then, the control unit 200 starts and instructs the broadcast receiving unit 170 to perform broadcast reception based on a broadcast type (i.e. TV mode or radio mode) specified in the first channel information piece and an airwave 1105 of a specified frequency or channel from a broadcast station 1104.

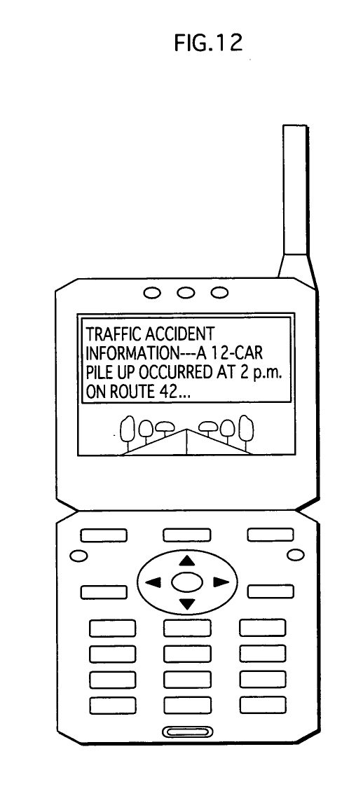

FIG. 12 shows an example in which the cell phone 100 receives and displays broadcast according to a channel information piece that is registered to the channel information table 901 and related to a traffic information center of a public highway corporation.

After the instruction of the broadcast reception, the control unit 200 receives the electric field intensity, which indicates an intensity of the airwave of the selected channel and is notified by the broadcast receiving unit 170. When the received electric field intensity is less than a predefined value, e.g. 25 μV/m, the control unit 200 determines that the intensity of the airwave is low, and instructs the broadcast receiving unit 170 to select the next channel information piece if there are multiple channel information pieces for the telephone number. If the electric field intensity of the channel information piece is again less than the predefined value, a similar process is repeated to the subsequent channel information pieces until a channel information piece for the telephone number having an electric field intensity of the predetermined value or more is found. If the electric field intensities of all the channel information pieces for the telephone number are less than the predefined value, the control unit 200 instructs the broadcast receiving unit 170 to end the reception.

When the reply from the communication base station in response to the communication request is BUSY, the control unit 200 instructs the communication unit 110 to make. retransmission (retry) to the telephone number after a certain period of time, e g. 30 seconds, while exercising control of broadcast reception.

If the reply to the retransmission is still BUSY, a similar retransmission process is repeated a determined number of times, e.g. five times, as long as the reply remains to be BUSY. Here, the period of time waited before retransmission and the number of retransmission to be performed are stored inside the control unit 200, and the user can define them at his discretion.

When the control unit 200 receives, from the communication base station, WAIT for the first reply and then receives a ringback tone signal for the subsequent reply, or receives BUSY for the first reply and then receives a ringback tone signal for the retransmission reply, the control unit 200 directs the broadcast receiving unit 170 to finish broadcast reception if it is receiving broadcast so that the user can concentrate on talking to the communication request destination.

Next is described the broadcast menu process performed by the control unit 200.

The control unit 200 displays the broadcast menu 501 when the user pushes a menu button 151. The user is able to, via the broadcast menu 501, register and refer to channel information pieces, and manually configure the setting for the TV or radio mode.

When the item of “channel information” is specified by pushing the number button “1” and the OK button 155 in the broadcast menu 501, the control unit 200 starts the channel information registration unit 180, which performs the registration process as previously mentioned.

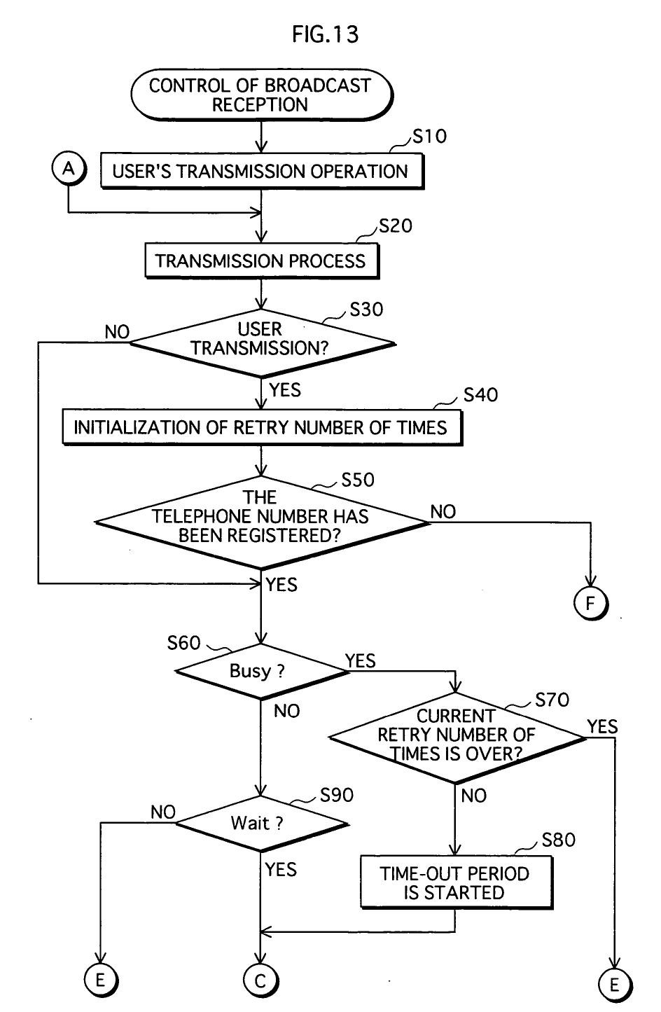

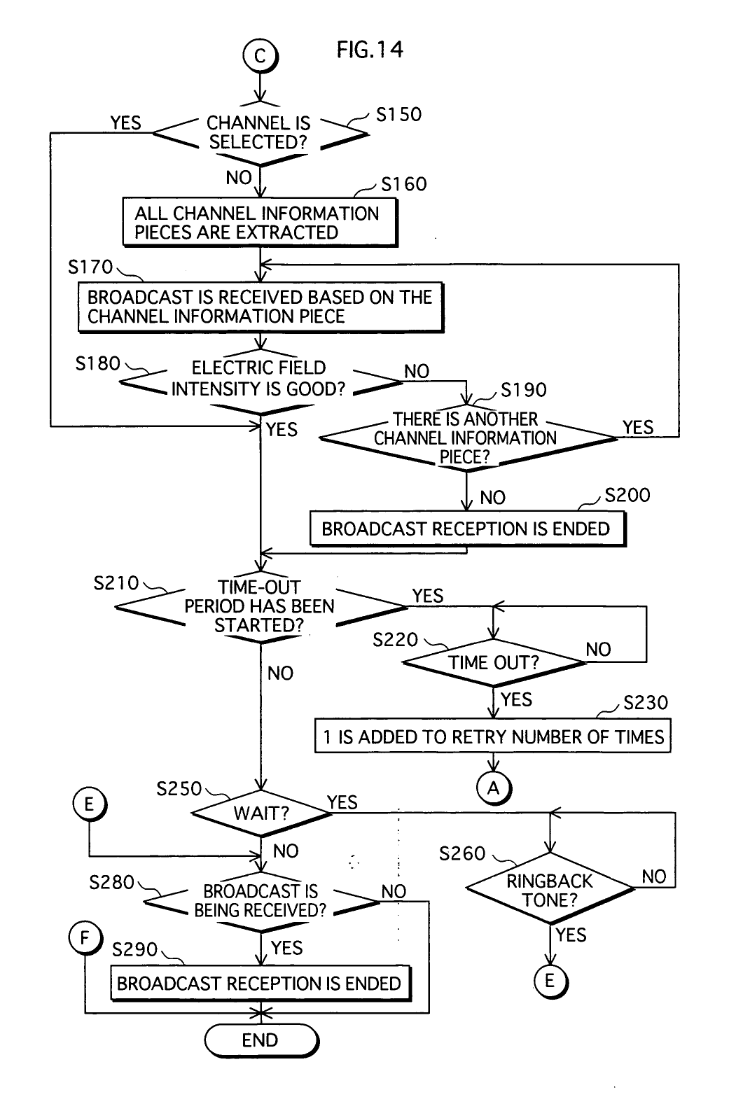

FIGS. 13 and 14 respectively show a first and a second half of the flowchart showing control operations of the broadcast reception in the mobile terminal, starting with transmission, receiving broadcast and ending the broadcast. The operations are described with the aid of FIGS. 13 and 14.

First, a communication request to a given telephone number is made by the user by operating on the operation unit 150 (Step S10). The communication unit 110 transmits a signal of a communication request to the telephone number to a base station (not shown) via the radio unit 101 (Step S20). In addition, the communication unit 110 notifies the control unit 200 of the transmission. Receiving the notification, the control unit 200 checks whether the transmission of the communication request to the telephone number was made by the user (Step S30). When determining that the communication request was made by the user, the control unit 200 regards the transmission as a new transmission and sets the retry number of times (counter) to zero (Step S40).

The control unit 200 checks whether the telephone number has been registered to the channel information table 901 (Step S50). If the telephone number has not been registered, broadcast reception is not necessary and the control unit 200 ends the process. Next, when a reply from the communication base station in response to the communication request to the telephone number is transmitted from the communication unit 110, the control unit 200 checks whether the reply is BUSY (Step S60).

When the reply is BUSY, the control unit 200 checks whether the current retry number of transmission is a limited count (Step S70). When it has reached the limited count, the process moves to Step S280. If it has not reached the limited count, the control unit 200 starts a time-out period required before the next retry is performed (Step S80), and the process moves to Step S150.

If the reply is not BUSY in Step S60, the voice judging unit 125 judges whether it is WAIT (Step S90). The control unit 200 receives the judgment result from the voice judging unit 125 via the voice processing unit 120. If judged as WAIT message, the reply is WAIT, and the process moves to Step S150. When the reply is neither BUSY nor WAIT, i.e. when a ringback tone is being received, the process moves to Step S280.

When the reply is BUSY or WAIT, the control unit 200 selects broadcast and checks whether it has already been received (Step S150). If having not received the broadcast, the control unit 200 extracts all channel information pieces for the telephone number from the channel information table 901 (Step S160). Then, the top channel information piece is first used.

The control unit 200 notifies the broadcast receiving unit 170 of the channel information piece, and instructs the broadcast receiving unit 170 to receive broadcast based on the channel information piece. The broadcast receiving unit 170 performs broadcast reception based on the notified channel information piece (Step S170), and notifies the control unit 200 of the electric field intensity of the frequency of the selected channel. The control unit 200 checks whether the electric field intensity is a predefined value or more (Step S180). If it is less than the predefined value, the control unit 200 selects the next channel information piece, if any (Step S190), the process moves to Step S170. If no channel information piece is left, the broadcast reception is ended (Step S200).

When a channel for broadcast has been selected, or the electric field intensity is appropriate, the control unit 200 checks whether the time-out period for a retry has been started (Step S210). If it has been started, the control unit 200 waits until the period is over (Step S220). When the time is over, “1” is added to the retry number (Step S230) and the process moves to Step S20 for a retransmission process.

When the time-out period has not been started, the control unit 200 checks whether the reply is WAIT (Step S250). If it is WAIT, the control unit 200 waits until receiving a ringback tone signal as the reply (Step S260). After the reception, the process moves to Step S280.

Finally, if receiving broadcast (Step S280), the control unit 200 instructs the broadcast receiving unit 170 to end the broadcast reception (Step S290).

Although the present invention has thus been described according to the above embodiment, it is a matter of course that the present invention is not limited to the above embodiment. The following cases are also within the scope of the present invention.

The above preferred embodiment is described assuming that the present invention is a cell phone, however, the present invention is applicable to any mobile terminal having a telephone function and a broadcast receiving function. Needless to add, the present invention is applicable to, for example, a PDA (Personal Data Assistant).

In the above preferred embodiment, whether a voice message of the reply is WAIT is determined by comparison of the amounts of characteristic used in pattern recognition. Instead, it may be determined by converting the voice message to characters and checking whether the fixed phrase of WAIT is included. It is a matter of course that accuracy of the judgment on whether the reply is WAIT may be improved by performing a semantic analysis.

In the preferred embodiment, when the reply is a voice message, the control unit 200 instructs, via the voice processing unit 120, the voice judging unit 125 to judge whether the voice message is WAIT message. In addition to this, the voice judgment unit 125 may judge the voice message is BUSY message indicating BUSY. In this case, the voice judging unit 125 stores therein a fixed phrase for judging BUSY message such as “Please make a call again” and some voice waveforms for the phrase, as in the case of the WAIT fixed phrase. Then, the voice judgment unit 125 determines that the voice message is BUSY message, WAIT message, or none of these. Then, when the reply is BUSY message, the control unit 200 may process the reply as BUSY. Note that BUSY message indicates that a communication connection in response to the communication request cannot be established, as in the case of a BUSY signal, and is notified by the communication base station to the communication requestor.

Although the electric field intensity is used to judge the intensity of the airwave above, it is a matter of course that the present invention is not limited to this. In addition, the predefined value of the electric field intensity used as a criterion for judging the intensity of the airwave can be changed.

The present invention may be a computer program that achieves the method by a computer, or may be a digital signal representing the computer program.

The present invention may also be achieved by a computer-readable recording medium, such as a semiconductor memory or the like, on which the above-mentioned computer program or digital signal is recorded.

The present invention may also be the computer program or digital signal to be transmitted via networks, as represented by telecommunications, wire/wireless communications, and the Internet.

### INDUSTRIAL APPLICABILITY

The mobile terminal according to the present invention is applicable in telecommunications technology.

1. A mobile terminal having a telephone function and a broadcast receiving function, comprising:
a storage unit storing one or more telephone numbers, each of which is associated with one or more channel information pieces;
a judging unit operable to judge, in a case where a caller makes a request for establishing a communication connection to one of the telephone numbers, whether the establishment requires time based on a reply signal from a communication base station that has received the request;
an extraction unit operable to perform a search in the storage unit when the judging unit determines that the establishment requires time, and extract the one or more channel information pieces associated with the one of the telephone numbers; and
a broadcast reception unit operable to receive a broadcast service using by one of the extracted channel information pieces.

2. The mobile terminal of claim 1, wherein
the judging unit determines that the establishment requires time when the reply signal is one of a 1st reply signal indicating that the establishment is not possible and a 2nd reply signal instructing the caller to hold.

3. The mobile terminal of claim 2, further comprising:
a retransmission unit operable to repeatedly retransmit, while the broadcast reception unit is receiving the broadcast service as a result of the reply signal being the 1st reply signal, the request at specified time intervals after reception of the 1st reply signal, until the judging unit determines that the establishment requires no time or until predefined number of retransmissions is reached.

4. The mobile terminal of claim 3, further comprising:
a broadcast reception terminating unit operable to terminate the reception of the broadcast service when the judging unit determines that the establishment requires no time.

5. The mobile terminal of claim 2, further comprising:
a broadcast reception terminating unit operable to terminate the reception of the broadcast service when the judging unit determines that the establishment requires no time in a case where the broadcast reception unit is receiving the broadcast service as a result of the reply signal being the 2nd reply signal.

6. The mobile terminal of claim 1, further comprising:
a detecting unit operable to detect airwave intensity, wherein
in a case where airwave intensity of the received broadcast service is less than a predefined value and there are a plurality of the extracted channel information pieces, the broadcast reception unit receives, singly and sequentially in order of extraction, broadcast services indicated by the plurality of the extracted channel information pieces until obtaining airwave intensity of a received broadcast service having the predefined value or more.

7. The mobile terminal of claim 1, wherein
the request is to establish an emergency communication connection to police or fire department.

8. A control method of a mobile terminal including a storage unit storing one or more telephone numbers, each of which is associated with one or more channel information pieces, and having a telephone function and a broadcast receiving function, the control method comprising the steps of:
judging, in a case where a caller makes a request for establishing a communication connection to one of the telephone numbers, whether the establishment requires time based on a reply signal from a communication base station that has received the request;
performing a search in the storage unit when the judging unit determines that the establishment requires time, and extracting the one or more channel information pieces associated with the one of the telephone numbers; and
receiving a broadcast service indicated by one of the extracted channel information pieces.
